(19) United States
(12) Patent Application Publication
(10) Pub. No.: US 2002/0196072 A1
(43) Pub. Date: Dec. 26, 2002

(54) Self-biased bias device with stable operating point

(75) Inventor: Francesco La Rosa, Rousset (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 10/164,839

(22) Filed: Jun. 6, 2002

(30) Foreign Application Priority Data
Jun. 8, 2001 (FR) 0107483

(51) Int. Cl. G05F 1/10

(52) U.S. Cl. 327/540

(57) ABSTRACT

A bias device includes a first branch and a second branch. The first branch includes a first bipolar device and a corresponding bias circuit. The second branch includes a second bipolar device and a corresponding bias circuit. A self-bias circuit is connected to the first and second branches. A first current generator injects a first auxiliary current into the first bipolar device. A second current generator injects a second current into the second bipolar device that is equal or proportional to the first auxiliary current. The bias device stabilizes the operating point of a circuit.

### FIELD OF THE INVENTION

The present invention relates to integrated circuits, and in particular, to a self-biased bias device.

### BACKGROUND OF THE INVENTION

Bias devices are commonly used in integrated circuits to generate reference voltages applied to current generators. They are also used in certain applications, such as voltage generators. FIG. 1 illustrates a block diagram of a prior art self-biased bias device 10. The device 10 comprises two branches B1, B2 each respectively comprising a bipolar device BE1, BE2 and a bias circuit BC1, BC2 for the bipolar device. The bipolar devices BE1, BE2 are respectively current monitored by bias voltages V1, V2 and may comprise resistors, diodes, bipolar transistors, MOS transistors, etc.

At least one of the bipolar devices is a nonlinear device so that the current/voltage transfer functions f1, f2 of the two bipolar devices meet and have a common operating point P1, represented in FIG. 2A. A self-bias circuit SBC monitors the bias voltages V1, V2 so that the device 10 stabilizes at the operating point P1 when the latter is supplied by a voltage Vcc. The device 10 delivers a reference voltage Vref generally equal to V1 or V2.

In the example in FIG. 2A, the bipolar devices BE1, BE2 respectively have non-linear transfer functions f1 and f2, and the operating point P1 is characterized by two currents I1 and I2 that are equal in the branches B1 and B2, and is characterized by two identical bias voltages V1, V2.

This bias device 10 does, however, have another operating point, which is shown in FIG. 2A. It is an operating point P0 of zero current and of zero voltage, the existence of which is due to the fact that each transfer function f1, f2 has a point of origin at zero. Therefore, upon switching on, the device 10 does not spontaneously switch to the operating point P1, and external means must be provided to reach the point P1. This external means is a so-called dynamic precharge circuit that applies a current or a voltage pulse to branches B1 and B2.

For a better understanding, FIGS. 3 and 4 represent two prior art embodiments of bias devices 11, 12. In each of the devices 11 and 12, the respective bias circuits BC1, BC2 of the branches B1, B2 are identical PMOS transistors TP1, TP2. The bipolar device of the branch B1 is an NMOS transistor TN1, and the bipolar device of the branch B2 is an NMOS transistor TN2 in series with a resistor R2. The bias voltages V1, V2 are applied to the gates G of transistors TN1, TN2. The transistor TN2 has a W/L ratio (gate width to length) that is higher than that of the transistor TN1. The differences between the voltage at the terminals of the transistor TN1 and the voltage at the terminals of the transistor TN2 are absorbed by the resistor R2.

In the device 11 shown in FIG. 3, the gates G of transistors TP1 and TP2 are interconnected and the transistor TP2 has its drain D drawn back onto its gate. The gates G of transistors TN1, TN2 are also interconnected and the transistor TN1 has its drain D drawn back onto its gate. The self-bias circuit SBC is implicit in this assembly and does not correspond to any specific active component, as the self-bias is achieved by the fact that each branch monitors the other branch (current control). This arrangement will be referred to as a reciprocal current mirror arrangement.

A dynamic precharge circuit adapted to the device 11 comprises, for example, a precharge transistor PT linked to the gates of transistors TN1, TN2 through a precharge capacitor PC. When a precharge signal PS is applied to the gate of the transistor PT, the latter goes into a transmission state and the gates of transistors TN1, TN2 receive sufficient voltage to force the transistors into a conducting state, which activates transistors TP1, TP2.

In the device 12 in FIG. 4, the transistors TN1 and TN2 each have their gate G drawn back onto their drain D (diode assembly). The self-bias circuit is a differential amplifier DA receiving voltages V1 and V2 at its negative and positive inputs, which are both the drain and gate voltages of the transistors TN1, TN2. The differential amplifier DA delivers a feedback signal EQ applied to the gates of the two transistors TP1, TP2. The operating point P1 is reached when the voltages V1 and V2 are equal.

A dynamic precharge circuit adapted to the device 12 comprises, for example, two transistors PT1, PT2 connected to the drains of transistors TN1, TN2 and are driven by the precharge signal PS. The voltages V1, V2 at the terminals of the bipolar devices are identical when the operating point P1 is reached. The reference voltage Vref delivered by devices 11 and 12 can be sampled on the drain (or the gate) of the transistor TN1 (FIG. 3) or on the drain (or the gate) of the transistor TN2 (FIG. 4).

With a bias device of the type described above, there is a risk that the transition from the operating point P0 to the operating point P1 does not take place correctly when the dynamic precharge circuit intervenes, such that the device can remain blocked on the operating point P0. This is shown schematically in FIG. 2B, where the two operating points P0 and P1 are represented by two possible positions of a ball placed on a rippled surface. For the ball to go from the operating point P0, shown by a recess, to the operating point P1, shown by another recess, a pulse must be applied to it. This example illustrates the fact that the ball may return to the point P0 if the pulse applied to it is too weak or too strong. If the pulse is too weak, the ball might not pass the peak. If the pulse is too strong, the ball might pass the peak, reach and go past the point P1, then come back to the point P0.

This means that designers of integrated circuits must take various precautions to make sure that a self-biased bias device will reach the operating point P1 when it is activated by the dynamic precharge device. Despite these precautions, the bias circuits can remain blocked. In any case, the calculations and final adjustments required to provide a dynamic precharge circuit complicate the design of a self-biased bias circuit and increases the cost thereof.

### SUMMARY OF THE INVENTION

In view of the foregoing background, an object of the present invention is to provide a straightforward and reliable manner that insures that a self-biased type bias device will set the required operating point.

This and other objects, advantages and features according to the present invention are provided by a bias device comprising a first branch and at least one second branch. The first branch comprises a first bipolar device and bias means for the first bipolar device. The second branch comprises a second bipolar device and bias means for the second bipolar device. The bias device comprises self-bias means so that the bias device has an operating point in which a current passing through the first branch is equal or proportional to a current passing through the second branch.

The bias device further comprises a first current generator in parallel with the bias means of the first bipolar device for injecting a first auxiliary current into the first bipolar device, and at least a second current generator in parallel with the bias means of the second bipolar device for injecting a second auxiliary current into the second bipolar device that is equal or proportional to the first auxiliary current.

The first and second current generators may comprise MOS transistors receiving identical gate voltages. The first branch and the second branch may be arranged as reciprocal current mirrors. The bias means of the first and second branches may comprise transistors driven by a signal delivered by a differential amplifier receiving voltages at an input of the terminals of the bipolar devices. The bipolar devices of the first and second branches may comprise NMOS transistors. At least one of the bipolar devices may comprise a diode or a transistor connected as a diode.

The present invention also relates to an integrated circuit on a silicon substrate, and comprises at least one bias device according to the present invention, and at least one circuit receiving a voltage sampled at one point of the bias device. According to one embodiment, the integrated circuit comprises a non-volatile memory array, and read circuits for the memory cells which are biased by a bias device according to the present invention.

The present invention also relates to a method for stabilizing the operating point of a bias device comprising a first branch and at least one second branch. The first branch comprises a first bipolar device and bias means for the first bipolar device. The at least a second branch comprises a second bipolar device and bias means for the second bipolar device. The bias device also comprises self-bias means of the device so that the bias device has an operating point in which a current passing through the first branch is equal or proportional to a current passing through the second branch.

The method comprises the injection of a first auxiliary current into the first bipolar device by means of a first current generator in parallel with the bias the first bipolar device. The method also comprises the injection of a second auxiliary current that is equal or proportional to the first auxiliary current by a second current generator in parallel with the bias means of the second bipolar device.

### BRIEF DESCRIPTION OF THE DRAWINGS

These and other objects, advantages and features of the present invention shall be presented in greater detail in the following description of the method according to the present invention and of examples of different embodiments of bias devices according to the present invention, given, but not limited to, in relation to the following figures:

FIG. 1 is a schematic diagram of a bias device according to the prior art;

FIG. 2A is a graph illustrating current/voltage curves that show operation of the bias device illustrated in FIG. 1;

FIG. 2B is a graph illustrating transition from one operating point to another for the bias device illustrated in FIG. 1;

FIG. 3 is a schematic diagram of a bias device according to the prior art;

FIG. 4 is a schematic diagram of another embodiment of a bias device according to the prior art;

FIG. 5 is a schematic diagram of a bias device according to the present invention;

FIG. 6A is a graph illustrating current/voltage curves showing operation of a bias device according to the present invention;

FIG. 6B is a graph illustrating stability of the operating point of a bias device according to the present invention;

FIG. 7 is a schematic diagram illustrating a first embodiment of a bias device according to the present invention;

FIG. 8 is a schematic diagram illustrating a second embodiment of a bias device according to the present invention;

FIG. 9 is a block diagram representing an example of an application of a bias device according to the present invention; and

FIG. 10 is a block diagram representing another example of an application of a bias device according to the present invention.

### DETAILED DESCRIPTION OF THE PREFERRED EMBODIMENTS

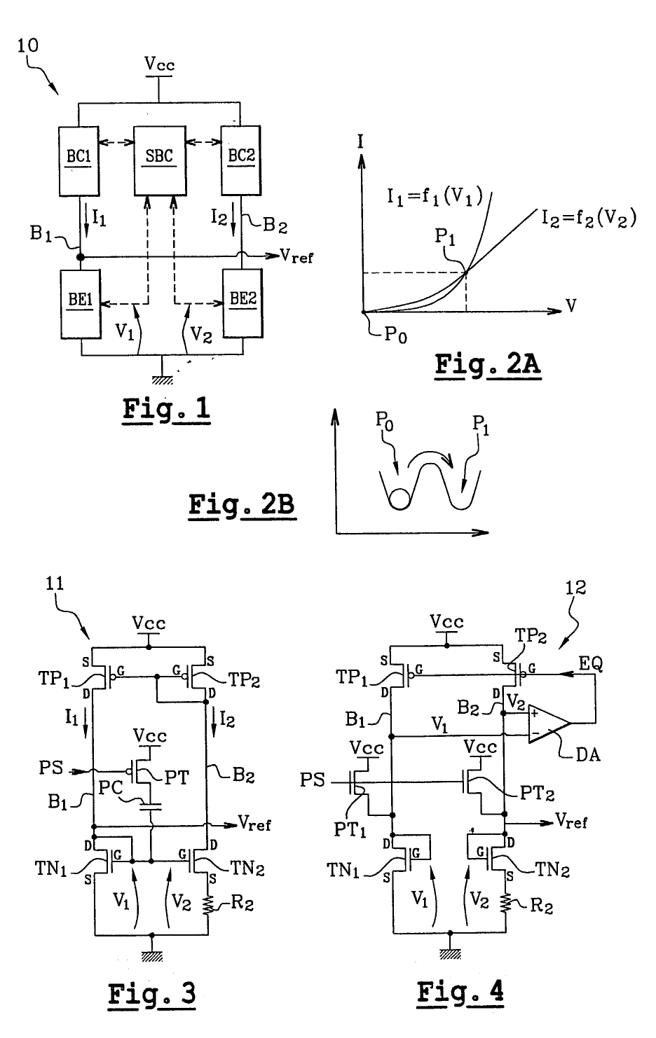

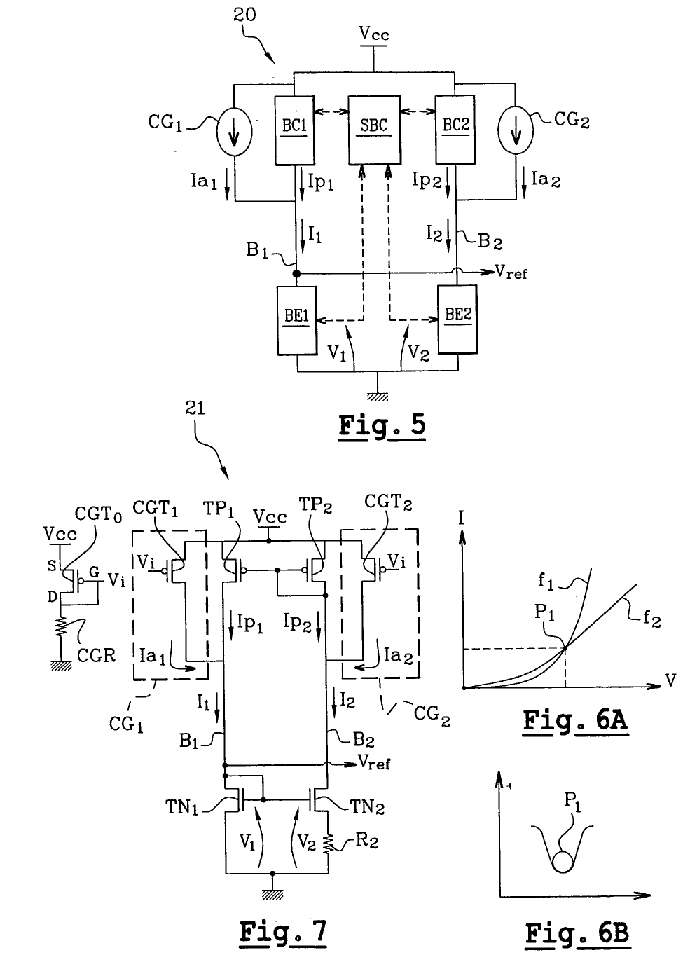

FIG. 5 is a schematic diagram of a bias device 20 according to the present invention which is of the self-biased type. The device 20 is, in its general structure, identical to the one described in reference to the FIG. 1, and comprises two branches B1 and B2, each respectively comprising a bias circuit BC1, BC2 and a bipolar device BE1, BE2. Each bias circuit BC1, BC2 is supplied by a voltage Vcc, and is connected to a terminal of the corresponding bipolar device BE1, BE2. The other terminal are connected to ground. Each bipolar device BE1, BE2 is respectively passed through by a current I1 and I2, and is current monitored by a voltage V1 and V2. A self-bias circuit SBC ensures the balance of the two branches so that the device 20 sets a defined operating point. In general, this operating point is characterized by equal or proportional currents I1, I2, and by equal voltages V1, V2.

The device 20 according to the present invention differs from a classic device by the fact that two current generators CG1, CG2 are arranged in parallel with the bias circuits BC1, BC2. The generator CG1 injects an auxiliary current Ia1 into the branch B1, and the generator CG2 injects an auxiliary current Ia2 into the branch B2. Due to the action of the self-bias circuit SBC, the currents I1 and I2 in the branches B1 and B2 remain equal or proportional and conform to the following relations:

1) I1=(Ia1+Ip1),

2) I2=(Ia2+Ip2), and

3) I1=K*I2.

Ip1 and Ip2 are the bias currents delivered by the circuits BC1 and BC2, and K is a constant generally chosen to be equal to 1.

The I1/I2 ratio is imposed by the self-bias circuit. Therefore, if the currents Ia1 and Ia2 change, the currents Ip1 and Ip2 change in the opposite way to comply with the relations (1), (2) and (3). Therefore, even if the current generators CG1, CG2 are not stable due to variations in the ambient temperature, for example, the stability of the device 20 is not affected. The two current generators according to the present invention can therefore be easily achieved, for example, by two MOS transistors receiving the same gate voltage, as will be described below.

One condition to be met for the implementation of the present invention is that the auxiliary currents Ia1 and Ia2 are less than I1 and I2. The currents Ia1 and Ia2 are chosen to be identical when the operating point of the device is such that I1 is equal to I2. They are chosen to be proportional in the K ratio if the constant K is different than 1. The currents Ia1 and Ia2 are preferably less than Ip1 and Ip2 and are, for example, on the order of 1 microampere or even less (one nanoampere may be sufficient) for currents I1 and I2 on the order of 10 microamperes.

The result obtained using the method according to the present invention is that the bias device 20 cannot remain blocked on an operating point P0 as discussed in the background section, in which the currents I1, I2 and the voltages V1, V2 are zero. As shown in FIG. 6A, the device 20 according to the present invention only comprises in reality one operating point P1 at the intersection of curves f1 and f2 representing the current/voltage transfer functions of the bipolar devices. This is also shown in FIG. 6B by a ball which is in a single recess representing the single operating point P1.

FIG. 7 shows the application of the method of the present invention to a bias device 21 of the type described in the background section in relation to FIG. 3. The same components are designated by the same references. The branch B1 of the device 21 therefore comprises a PMOS transistor TP1 in series with an NMOS transistor TN1, and the branch B2 comprises a PMOS transistor TP2 in series with an NMOS transistor TN2 and a resistor R2. The transistor TN2 has a W/L ratio (gate width to length) that is higher than that of the transistor TN1. The difference between the voltages at the terminals of transistors TN1 and TN2 are absorbed by the resistor R2. Generally speaking, the transistor TN2 is achieved by arranging several identical transistors in parallel (not shown).

The voltage Vcc is applied to the sources S of the transistors TP1, TP2. The source S of the transistor TN1 is connected to ground while the source S of the transistor TN2 is linked to ground through the resistor R2. The gates G of transistors TP1, TP2 and the drain of the transistor TP2 are interconnected. The gates G of transistors TN1, TN2 and the drain of the transistor TN1 are also interconnected. The gate voltages V1, V2 of these two transistors are therefore equal. The output voltage Vref delivered by the device 21 is sampled, for example, on the drain of the transistor TN1 (voltage V1).

The current generator CG1 according to the present invention comprises a PMOS transistor CGT1, the source of which receives the voltage Vcc and the drain D of which is connected to the drains of transistors TP1 and TN1. The current generator CG2, of the same structure as the generator CG1, comprises a PMOS transistor CGT2. The source of this transistor receives the voltage Vcc, and its drain D is connected to the drains of transistors TP2 and TN2. The transistors CGT1, CGT2 are identical and receive an identical gate voltage Vi. The auxiliary currents Ia1 and Ia2 are therefore identical to within manufacturing tolerances.

The voltage Vi is obtained, for example, by an auxiliary branch comprising a PMOS transistor CGTO arranged as a diode, i.e., gate G is connected to the drain D. This transistor receives the voltage Vcc at its source and has its drain linked to ground through a resistor CGR. The voltage Vi is sampled on the gate of the transistor CGTO. Since the two branches B1, B2 are arranged as reciprocal current mirrors, and since the transistors TP1, TP2 are identical, the device self-biases at an operating point in which I1=I2 and V1=V2.

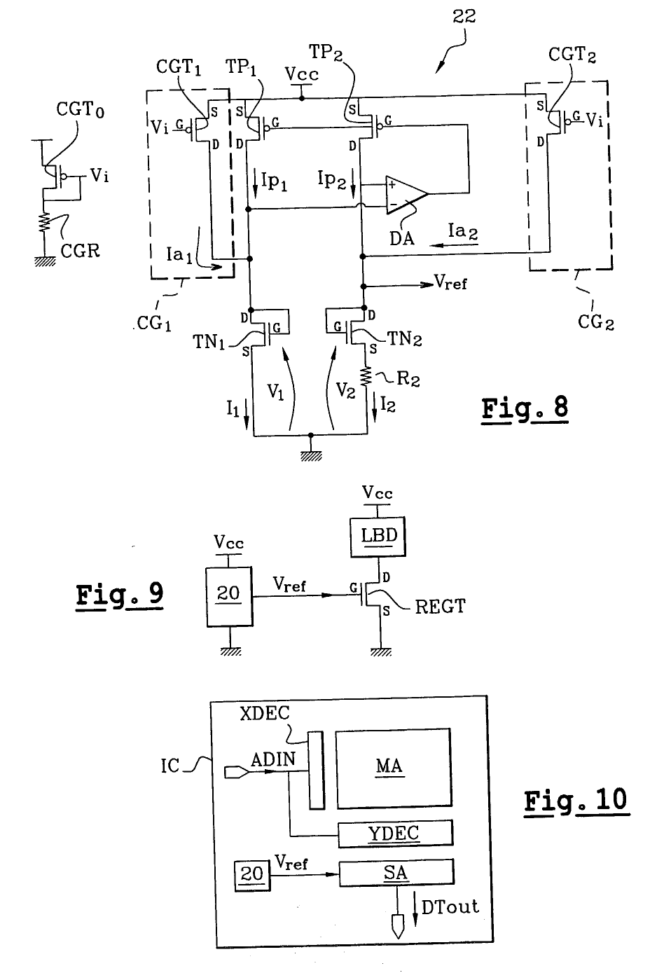

FIG. 8 shows the application of the method of the present invention to a bias device 22 of the type described in the background section in reference to FIG. 4. The branches B1 and B2 and the current generators CG1, CG2 have structures identical to those of the device 21 that has just been described. The gates of transistors TN1 and TN2 are not interconnected and each transistor TN1 and TN2 has its gate connected to its drain (a diode assembly). The transistor TP2 does not have its gate connected to its drain. The gates of transistors TP1, TP2 are driven by a feedback signal EQ delivered by a differential amplifier DA. The differential amplifier DA receives voltages V1 and V2 at its negative and positive inputs present on the gates and drains of transistors TN1 and TN2. The output voltage Vref delivered by the device 21 is sampled, for example, on the drain of the transistor TN2 (voltage V2).

As the transistors TP1, TP2 are identical, the device 22 self-biases at an operating point in which I1=I2 and V1=V2. The constant K mentioned above may, however, be different than 1 by choosing transistors TP1 and TP2 that are of different sizes (W/L ratios), and transistors TN1 and TN2 have the same size ratio as transistors TP1 and TP2. This can be obtained, for example, by arranging two transistors TP1 and two transistors TN1 in parallel in the branch B1.

As it will be clear to those skilled in the art, a bias device according to the present invention is susceptible to different variations. Although the description above is of examples of the implementation of the present invention in devices only comprising two branches in parallel, self-biased devices with three branches or more may be provided in some applications. In this case, a current generator is provided in parallel with the bias circuits present in each branch. Moreover, a bias device according to the present invention is susceptible to different applications, and generally, any known application for classic bias devices.

FIG. 9 represents schematically an example of an application in which the voltage Vref delivered by a device 20 according to the present invention is applied to the gate of an NMOS type regulation transistor REGT. The transistor REGT has its source connected to ground, and its drain connected to a device LBD which is supplied by the voltage Vcc. As the transistor REGT is driven by the voltage Vref, it regulates the current I passing through the device LBD. This current I is, for example, equal to the current II of the device 20 if the voltage Vref is sampled at the terminals of the transistor TN1 of the branch B1, and if the transistor REGT has the same W/L ratio as the transistor TN1.

As another example of an application, FIG. 10 represents an integrated circuit IC comprising a memory array MA, a line decoder XDEC, a column decoder YDEC and a row of read amplifiers forming a read block SA. The memory array MA comprises, for example, volatile memory cells that includes floating gate transistors. When an ADIN address is applied to the decoders XDEC and YDEC through an input terminal of the integrated circuit, the read block SA is activated to read memory cells selected by the decoders XDEC and YDEC. A bias circuit 20 according to the present invention delivers a reference voltage Vref to the read block SA which allows the read block to determine the transmission or non-transmission state of the floating gate transistors of the memory cells selected. The binary data DTOUT are delivered by the read block SA to an output terminal of the integrated circuit IC.

That which is claimed is:

1. A bias device (20, 21, 22) comprising:
a first branch (B1) comprising a first bipolar device (BE1, TN1) and bias means (BC1, TP1) of the first bipolar device,
at least a second branch (B2) comprising a second bipolar device (BE2, TN2) and bias means (BC2, TP2) of the second bipolar device, and
self-bias means (SBC, DA), so that the bias device has an operating point (P1) in which a current (I1) passing through the first branch is equal or proportional to a current (I2) passing through the second branch,
characterised in that it comprises:
a first current generator (CG1) in parallel with the bias means (BC1, TP1) of the first bipolar device, injecting a first auxiliary current (Ia1) into the first bipolar device, and
at least a second current generator (CG2) in parallel with the bias means (BC2, TP2) of the second bipolar device, injecting a second auxiliary current (Ia2) into the second bipolar device that is equal or proportional to the first auxiliary current (Ia1).

2. Device according to claim 1, in which the first and second current generators (CG1, CG2) comprise MOS transistors (CGT1, CGT2) receiving identical gate voltages (Vi).

3. Device according to one of claims 1 and 2, in which the first branch and the second branch are arranged as reciprocal current mirrors.

4. Device according to one of claims 1 to 3, in which the bias means of the first and second branch comprise transistors (TP1, TP2) driven by a signal (EQ) delivered by a differential amplifier (DA) receiving voltages (V1, V2) at input present at the terminals of the bipolar devices.

5. Device according to one of claims 1 to 4, in which the bipolar devices of the first and second branch comprise NMOS transistors (TN1, TN2).

6. Device according to one of claims 1 to 5, in which at least one of the bipolar devices comprises a diode or a transistor arranged as a diode (TN1).

7. Integrated circuit on silicon substrate (IC), characterised in that it comprises at least one bias device (20) according to one of claims 1 to 6, and at least one circuit (SA) receiving a voltage (Vref) sampled at one point of the bias device.

8. Integrated circuit according to claim 7, characterised in that it comprises a non-volatile memory plane (MA) and read circuits (SA) of memory cells biased by a bias device (20) according to one of claims 1 to 6.

9. Method for stabilising the operating point of a bias device (20, 21, 22) comprising:
a first branch (B1) comprising a first bipolar device (BE1, TN1) and bias means (BC1, TP1) of the first bipolar device,
at least a second branch (B2) comprising a second bipolar device (BE2, TN2) and bias means (BC2, TP2) of the second bipolar device, and
self-bias means of the device (SBC, DA), so that the bias device has an operating point (P1, Vp, Ip) in which a current (I1) passing through the first branch is equal or proportional to a current (I2) passing through the second branch,
a method characterised in that it comprises:
the injection of a first auxiliary current (Ia1) into the first bipolar device, by means of a first current generator (CG1) in parallel with the bias means (BC1, TP1) of the first bipolar device, and
the injection of a second auxiliary current (Ia2) that is equal or proportional to the first auxiliary current (Ia1), by means of a second current generator (CG2) in parallel with the bias means (BC2, TP2) of the second bipolar device.

10. Method according to claim 9, in which the first and second current generators (CG1, CG2) are achieved by means of two MOS transistors (CGT1, CGT2) to which identical gate voltages (Vi) are applied.

11. Method according to one of claims 9 and 10, in which the first branch and the second branch are arranged as reciprocal current mirrors.

12. Method according to one of claims 9 and 10, in which the first and the second branch are biased by transistors (TP1, TP2) driven by a signal (EQ) delivered by a differential amplifier (DA) receiving voltages (V1, V2) at input present at the terminals of the bipolar devices.

13. Method according to one of claims 9 to 12, in which the bipolar devices of the first and second branch comprise NMOS transistors (TN1, TN2).

14. Method according to one of claims 9 to 13, in which at least one of the bipolar devices comprises a diode or a transistor arranged as a diode (TN1).

15. Method according to one of claims 9 to 14, comprising a step of sampling a reference voltage (Vref) at one point of the bias device and applying the reference voltage to at least one component (LBD, SA) of an integrated circuit.
